(19) United States
(12) Patent Application Publication
(10) Pub. No.: US 2026/0065200 A1
(43) Pub. Date: Mar. 5, 2026

(54) SYSTEM AND METHOD FOR FORECASTING LOYALTY PROGRAM LIABILITY

(71) Applicant: NCR VOYIX CORPORATION, ATLANTA, GA (US)

(72) Inventor: Itamar David Laserson, Givat Shmuel (IL)

(21) Appl. No.: 18/821,423

(22) Filed: Aug. 30, 2024

(51) Int. Cl. G06Q 10/0635; G06Q 30/0202; G06Q 30/0204; G06Q 30/0226

(52) U.S. Cl. CPC G06Q 10/0635; G06Q 30/0202; G06Q 30/0205; G06Q 30/0227

(57) ABSTRACT

In a system and method for providing a points liability forecast, data associated with transactions related to a retail loyalty program based on points accumulated by each customer enrolled in the retail loyalty program is received and stored. One or more training sets of data is created based on the received and stored data. The one or more training sets are used to generate a machine-learning model that forecasts points liability. Input parameters related to retail loyalty program are received from aa user, for input to the machine learning model. Forecast parameters based on the input parameters are received, as output from the machine learning model. Finally, the forecast parameters are provided to the user via an interface.

### FIELD

This disclosure relates generally to a system and method for forecasting loyalty program liability, and more particularly to a system and method in which a machine learning model on a remote server is generated and used to forecast loyalty program liability.

### BACKGROUND

Many retailers have loyalty programs that they offer to their customers. The customer agrees to let the retailer track their purchases with the retailer and in exchange the customer may earn rewards, such as discounts, free items, and/or options to purchase goods with accumulated loyalty points. The retailer is able to customize offers to their customers using transaction histories and analyze transaction patterns to improve sales and operations of stores using transaction histories. The customers present their loyalty card or provide/enter identifying information linked to their loyalty accounts during a checkout; this allows the retailer to link the customers to their loyalty accounts during transactions. Such loyalty programs are widely perceived to increase loyalty customer engagement, and loyalty points are one the most commonly used types of loyalty programs, with customers gaining points upon purchases and then redeeming them in future transactions.

However, one of the main challenges in such loyalty programs is that loyalty points introduce a points liability. The retailers perceive loyalty points as a debt to their customers. In financial books, accumulated loyalty points are reduced from the total revenue of the retailer. It is an unpredictable, hard to manage entry (essentially a liability) in the financial books of the retailer and that can make planning difficult on the business side.

There is thus a need for a way to make loyalty point liability more predictable. This will help retailers create better financial plans for their overall business, detect areas of inefficiencies in the loyalty points program by identifying location or customer-type trends (e.g., differences in points redemption at different locations or by different customer types, identify problems such as excessive point liability and take action to change the program in order to reduce this type of problem, and generate more effective promotions in order to increase customer engagement.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system according to an aspect of the current disclosure;

FIG. 2 is a schematic block diagram of an example computing system for use in the system of the current disclosure;

FIG. 3 is a block diagram of a business office computer for use in the system of the current disclosure;

FIG. 4 is a block diagram of a retail location server for use in the system of the current disclosure;

FIG. 5 is a block diagram of a remote server for use in the system of the current disclosure; and

FIG. 6 is a flowchart of a method of operation of the system of the current disclosure.

### DETAILED DESCRIPTION

In the present disclosure, like reference numbers refer to like elements throughout the drawings, which illustrate various exemplary embodiments of the present disclosure.

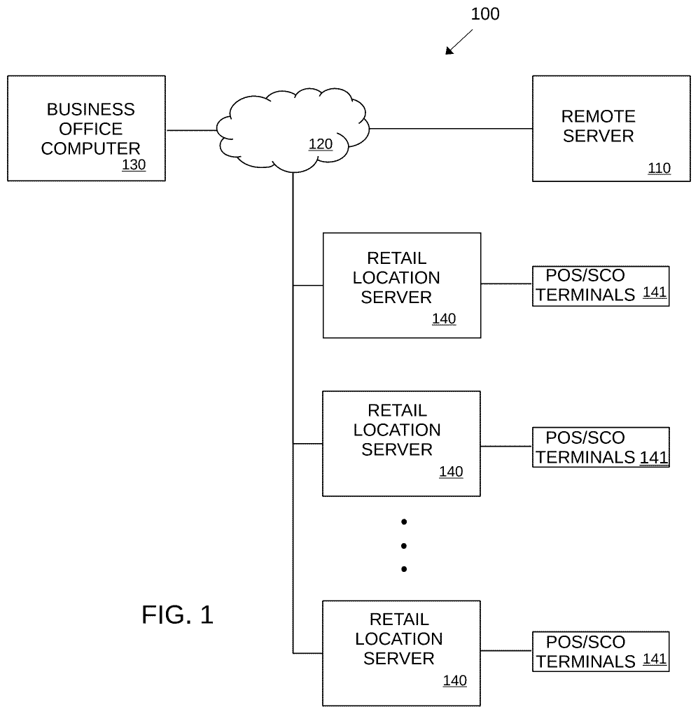

Referring now to FIG. 1, a system 100 for forecasting loyalty program liability for a retailer includes a remote server 110, a business office computer 130, a retail location server 140 each of the retailer's locations, all coupled via a network 120. Each retail location server 140 is coupled to a plurality of point of sale (POS) and/or self-checkout (SCO) terminals 141 respectively. Each of the servers/computers shown in FIG. 1 is configured to cooperate in providing a user with a loyalty program liability forecast, as described herein. The business office computer 130 may be at the same location as the remote server 110 or may be in a different location. In some cases, the applications provided on the business office computer 130 may be implemented, at least in part, on the remote server 110 and accessed via an interface thereto.

First, as shown in FIG. 3, the business office computer 130 includes a memory 132 that has a non-transitory computer-readable storage medium portion 134 that includes a loyalty program administration module 136 and a loyalty program status application programming interface (API) 138.

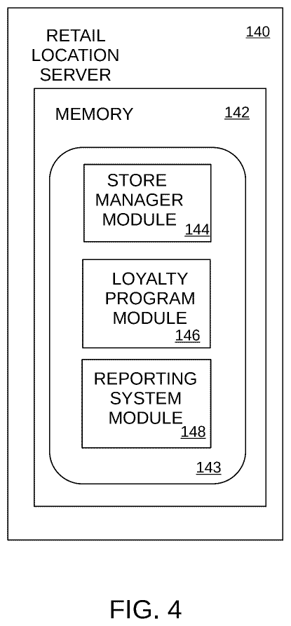

Next, as shown in FIG. 4, each retail location server 140 includes a memory 142 that has a non-transitory computer-readable storage medium portion 143 that includes a store manager module 144, a loyalty program module 146, and a reporting system module 148 which are discussed below.

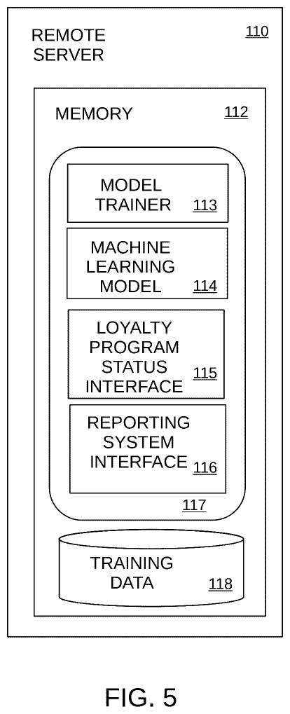

Further, as shown in FIG. 5, the remote server 110 includes a memory 112, that has a non-transitory computer-readable storage medium portion 117 that includes a model trainer module 113, a machine learning model 114, a loyalty program status interface 115, and a reporting system interface 116. Remote server 110 also includes a memory 118 for storing training data, i.e., the data that is used to train the machine learning model 114.

The loyalty program administration module 136 in business office computer 130 allows a user such as a loyalty program manager to administer a loyalty program by specifying parameters for such program and communicating the parameters to the loyalty program module 146 at each retail location server 140.

The loyalty program status API 138 in business office computer 130 provides an interface that allows a user to provide information to and receive information from the loyalty program status interface 115. This allows the user, typically a loyalty program manager, to enter input information for the machine learning model 114 and receive the output therefrom, as discussed below. This allows the loyalty program manager to receive loyalty program forecast information (the output of the machine learning model 114) based on such input information (e.g., via a user interface on the business office computer 130).

The store manager module 144 in each retail location server 140 is coupled to coordinate the operation of all of the associated POS/SCO terminals 141at a respective retail location.

The loyalty program module 146 in each retail location server 140 configures each of the POS/SCO terminals 141at a respective retail location to administer the loyalty program based upon the parameters received from the loyalty program administration module 136 by, e.g., enrolling customers, providing loyalty points according to such parameters to an enrolled customer during a transaction covered by the loyalty program, and redeeming loyalty points to an enrolled customer during a transaction covered by the loyalty program. The loyalty program module 146 also receives data point adjustments history data for activities done by a customer service interface at a retailer location that were not associated with a retail transaction and provides such information to the reporting system interface 116 at the remote server 110.

The reporting system module 148 in each retail location server 140 receives information for each customer transaction, including for the purposes of the present disclosure, transaction documents, e.g., transaction document management (TDM) data, for transactions that included points gained and/or redeemed and all loyalty members data (enrolled customers) as captured in consumer data management, CDM, records, and communicates such information to the reporting system interface 116 at the remote server 110.

The model trainer module 113 in the remote server 110 trains the machine learning model 114 based on the data stored in the training data memory 118, as discussed below. Model trainer module 113 may generate one set or more than one subsets of training data from the training data memory 118 for use in both creating and evaluating the machine learning model 114.

The loyalty program status interface 115 in the remote server 110 interacts with the loyalty program status API 138 in the business office computer 130, as discussed above, to receive input information provided by a user, forwards such input information to the machine learning model 114, and then receives output information and forwards such output information (i.e., the loyalty program forecast information) to the loyalty program status API 138.

The reporting system interface 116 in the remote server 110 receives information from the loyalty program module 146 and the reporting system module 148 at each retail location server 140 and stores such data in the training data memory 118.

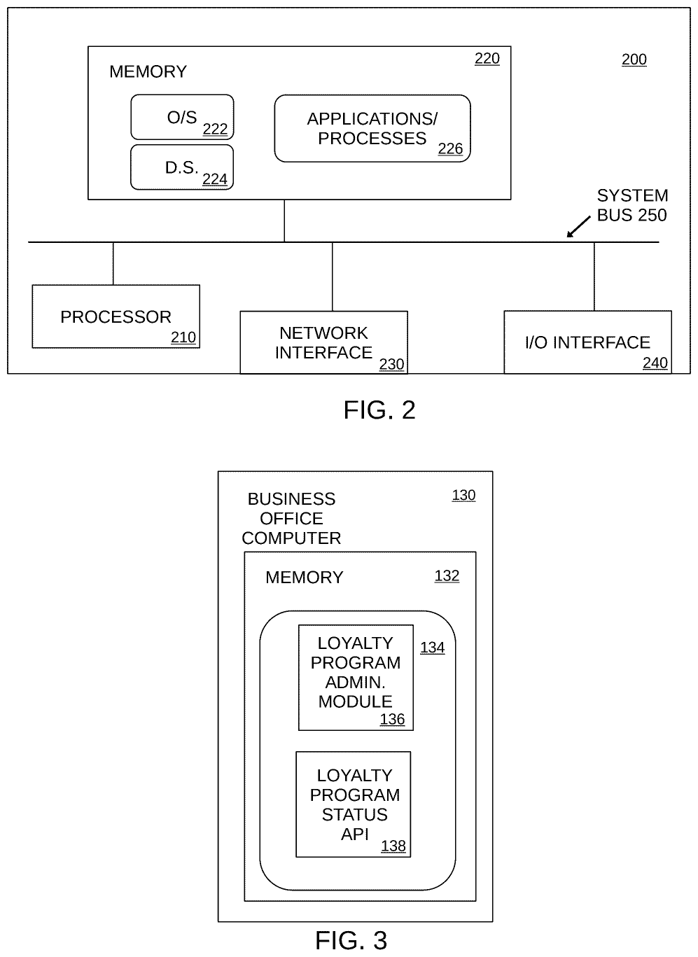

FIG. 2 is a schematic block diagram of an example computing system or device 200 that may be used with one or more embodiments described herein, e.g., as the servers 110, 140 or the business office computer 130 shown in FIG. 1. Device 200 may include a processor 210 (which may be a single processor or a plurality of linked processors), a memory 220, one or more network interfaces 230 (e.g., wired, wireless, etc.), and one or more input/output (I/O) interfaces 240, which may be interconnected by a system bus 250. The network interface(s) 230 and the I/O interface(s) 240 are referred to in the singular hereinafter for ease of explanation. The network interface 230 contains the necessary circuitry for communicating data over links coupled to the network 120. The network interface 230 may be configured to transmit and/or receive data using a variety of different communication protocols. Note, further, that configuration of device 200 shown in FIG. 2 is merely illustrative, and device 200 may have multiple types of network connections via multiple network interfaces 230, e.g., wireless and wired/physical connections.

The memory 220 may include a plurality of storage locations that are addressable by the processor 210 and the network interface 230 for storing software programs and data structures associated with the embodiments described herein. The parts of memory 220 that store software programs, including any operating system, may be a non-transitory computer-readable storage medium. The processor 210 may comprise hardware elements or hardware logic adapted to execute software programs and manipulate the data structures 224. An operating system 222, portions of which are typically resident in memory 220 and executed by the processor 210, functionally organizes the device 200 by, among other things, invoking operations in support of software processes and/or services executing on the device 200. These software processes and/or services may include one or more applications/processes 226.

The I/O interface 240 may not be present in all embodiments (e.g., when the device 200 is a cloud-based server), but when present, typically includes a user interface (UI) that has an input device, such as an alpha-numeric keypad (e.g., a keyboard) for inputting alpha-numeric and other information, a pointing device (e.g., a mouse, a trackball, stylus, or cursor direction keys), a touchscreen, a microphone, and a camera.

The model trainer module 113 trains the machine learning model 114 to forecast loyalty program liability. The model trainer module 113 uses the training data (e.g., subsets thereof) stored in the training data memory 118 at the remote server 110. This data may include, for example., all transaction documents, e.g., transaction document management (TDM) data, for transactions that included points gained and/or redeemed; all point adjustments history data for activities done by customer service at a retailer that were not associated with a retail transaction; all loyalty members data as captured in consumer data management, CDM, records; all promotions data that involve points; and points expirations data for each loyalty member, i.e., how many points will be expired at each date.

Once the machine learning model 114 is trained, when input information is received via the loyalty program status interface 115 that is coupled to the loyalty program status API 138 running on the business office computer 130, the machine learning model 114 processes that input information and provides forecast information as an output. The user (e.g., a loyalty program manager) of the business office computer 130 specifies the input information, including, in one example, the loyalty program for which a forecast is requested, the loyalty customer segment to be included in the forecast (e.g., all members or a specified subset thereof), and the forecast period.

Based on the input information from the user, the machine learning model 114 produces an output that includes one or more of the following: a forecast of loyalty points to be gained by customers during a defined forecast period, a forecast of loyalty points to be redeemed by customers during the defined forecast period, a forecast of loyalty points adjustments to be made during the defined forecast period, and a forecast of the retailer's overall points liability at the end of the defined forecast period.

The system and method of the present disclosure employs a machine learning model 114 that enables a loyalty program manager to obtain a reliable forecast of overall points liability for use in, e.g., updating the retailer's financial books and to aid in financial planning. The system and method of the present disclosure also allows the loyalty program manager to use the machine learning model 114 to generate forecasting liability trends that are useful in determining whether a promotion strategy for a currently loyalty program encourages an increase or a reduction of points liability. Further, the system and method of the present disclosure allows the loyalty program manager to use the machine learning model 114 to predict the impact of proposed new promotions on liability by applying the machine learning model 114 with and without such new promotions and comparing the relative outputs.

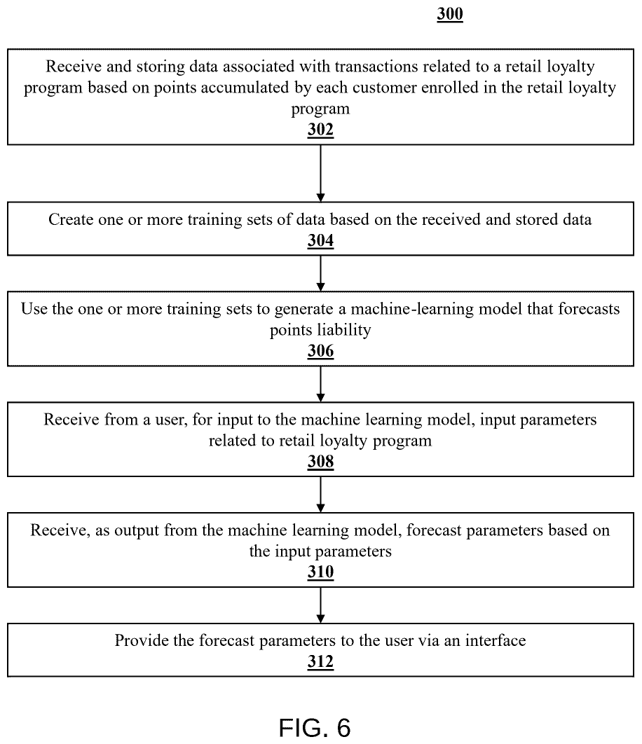

FIG. 6 is a flowchart of an example of a method 300 according to the instant disclosure. As shown in FIG. 6, method 300 may include receiving and storing data associated with transactions related to a retail loyalty program based on points accumulated by each customer enrolled in the retail loyalty program (block 302). For example, the remote server 110 may receive and store, in training data memory 118, data associated with retail loyalty program transactions including, for example, all transaction documents, e.g., transaction document management (TDM) data, for transactions that included points gained and/or redeemed; all point adjustments history data for activities done by customer service at a retailer that were not associated with a retail transaction; all loyalty embers data as captured in consumer data management, CDM, records; all promotions data that involve points; and points expirations data for each loyalty member, i.e., how many points will be expired at each date.

As also shown in FIG. 6, method 300 may include creating one or more training sets of data based on the received and stored data (block 304). For example, the model trainer module 113 in remote server 110 may create one or more training sets of data based on the received and stored data as described above. As further shown in FIG. 6, method 300 may include using the one or more training sets to generate a machine learning model 114 that forecasts points liability (block 306). For example, the model trainer module 113 may use the one or more training sets to generate a machine-learning model that forecasts points liability by providing, for example, a forecast of loyalty points to be gained by customers during a defined forecast period, a forecast of loyalty points to be redeemed by customers during the defined forecast period, a forecast of loyalty points adjustments to be made during the defined forecast period, and/or a forecast of the retailer's overall points liability at the end of the defined forecast period.

As further shown in FIG. 6, method 300 may include receiving from a user input parameters related to the retail loyalty program for input to the machine learning model (block 308). For example, the machine learning model 114 may receive, from a user, input parameters related to the retail loyalty program for input to the machine learning model 114, the input parameters including, for example, the loyalty program for which a forecast is requested, the loyalty customer segment to be included in the forecast (e.g., all members or a specified subset thereof), and the forecast period. As further shown in FIG. 6, method 300 may include receiving forecast parameters based on the input parameters as output from the machine learning model 114 (block 310). As also shown in FIG. 6, method 300 may include providing the forecast parameters to the user via an interface (block 312). For example, the forecast parameters may be provided to the user via the loyalty program status API 138 on the business office computer 130 that is linked to the loyalty program status interface 115 in the remote server 110.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

1. A method for forecasting retail loyalty program financial liabilities, comprising:
receiving, from one or more point-of-sale (POS) systems, retail transaction records comprising purchased item identifiers, quantities, prices, and associated loyalty program point events;
receiving, from one or more customer service systems, adjustment records associated with loyalty point issuance, returns, expirations, bonuses, and manual overrides;
creating one or more training sets of data that each combines the POS transaction records with the adjustment records, wherein each training set of data includes a plurality of structured and unstructured data fields representative of multi-dimensional customer loyalty interactions;
training, by one or more processors, a machine-learning model using the one or more training sets, machine-learning model being configured to capture temporal and non-linear relationships between retail activity and loyalty point liability;
receiving from a user, for input to the machine learning model, input parameters related to the retail loyalty program and a defined forecast scenario;
receiving, as output from the machine learning model, forecast parameters based on the input parameters that provide a forecasted loyalty point liability balance for a defined future period; and
providing the forecast parameters to the user;
wherein the one or more training sets of data includes at least two distinct data types selected from: (i) item-level POS transaction data, (ii) customer profile and segment data, (iii) promotional campaign metadata, (iv) point expiration schedules, and (v) customer service adjustment records.

2. (canceled)

3. The method of claim 1, wherein the the adjustment records comprise customer-service-initiated loyalty point corrections that are not associated with a retail purchase transaction.

4. The method of claim 1, wherein the retail transaction records comprise all loyalty members data as captured in consumer data management records and/or all promotions data that involve points.

5. The method of claim 1, wherein the retail transaction records comprise points expiration data for each enrolled loyalty member.

6. The method of claim 1, wherein the input parameters related to the retail loyalty program comprise the loyalty program for which a forecast is requested, the loyalty customer segment to be included in the forecast, and/or the forecast period.

7. The method of claim 1, wherein the forecast parameters comprise a forecast of loyalty points to be gained by customers during a defined forecast.

8. The method of claim 1, wherein the forecast parameters comprise a forecast of loyalty points to be redeemed by customers during the defined forecast period during retail purchase transactions at point-of-sale systems.

9. The method of claim 1, wherein the forecast parameters comprise a forecast of loyalty points adjustments to be made during the defined forecast period initiated by retailer personnel.

10. The method of claim 1, wherein the forecast parameters comprise a forecast of the retailer's overall points liability at the end of the defined forecast period.

11. A system for forecasting retail loyalty program liabilities, comprising:
a retail location server comprising at least one processor and an associated non-transitory computer-readable storage medium, the retail location server being coupled to one or more point-of-sale (POS) systems;
a remote server comprising at least one processor and an associated non-transitory computer-readable storage medium, the remote server coupled to the retail location server;
the non-transitory computer-readable storage medium associated with the remote server comprising executable instructions; and
the executable instructions when executed by at least one processor in the remote server cause the at least one processor to perform operations, comprising:
receiving, from the one or more POS systems via the retail location server, retail transaction records comprising purchased item identifiers, quantities, prices, and associated loyalty program point events;
receiving, from one or more customer service systems, adjustment records associated with loyalty point issuance, returns, expirations, bonuses, and manual overrides;
creating one or more training sets of data that each combine the POS transaction records with the adjustment records, wherein each training set of data includes a plurality of structured and unstructured data fields representative of multi-dimensional customer loyalty interactions;
training a machine-learning model using the one or more training sets, the machine-learning model being configured to capture temporal and non-linear relationships between retail activity and loyalty point liability;
receiving from a user, for input to the machine learning model, input parameters related to the retail loyalty program and a defined forecast scenario;
receiving, as output from the machine learning model, forecast parameters based on the input parameters that provide a forecasted loyalty point liability balance for a defined future period; and
providing the forecast parameters to the user;
wherein the one or more training sets of data include at least two distinct data types selected from: (i) item-level POS transaction data, (ii) customer profile and segment data, (iii) promotional campaign metadata, (iv) point expiration schedules, and (v) customer service adjustment records.

12. The system of claim 11, comprising a business office computer comprising at least one processor and an associated non-transitory computer-readable storage medium, the non-transitory computer-readable storage medium associated with the business office computer comprising executable instructions and the executable instructions when executed by at least one processor in the business office computer cause the at least one processor to perform operations, comprising:
forward input parameters related to the retail loyalty program and the defined forecast scenario entered by the user to the remote server;
receive the forecast parameters based on the input parameters from the remote server; and
display the received forecast parameters on a user interface associated with the business office computer.

13. The system of claim 11, wherein the the adjustment records comprise customer-service-initiated loyalty point corrections that are not associated with a retail purchase transaction.

14. The system of claim 11, wherein the retail transaction records comprise all loyalty members data as captured in consumer data management records and/or all promotions data that involve points.

15. The system of claim 11, wherein the retail transaction records comprise points expiration data for each enrolled loyalty member.

16. The system of claim 11, wherein the input parameters related to the retail loyalty program comprise the loyalty program for which a forecast is requested, the loyalty customer segment to be included in the forecast, and/or the forecast period.

17. The system of claim 11, wherein the forecast parameters comprise a forecast of loyalty points to be gained by customers during a defined forecast period.

18. The system of claim 11, wherein the forecast parameters comprise a forecast of loyalty points to be redeemed by customers during the defined forecast period during retail purchase transactions at point-of-sale systems.

19. The system of claim 11, wherein the forecast parameters comprise a forecast of loyalty points adjustments to be made during the defined forecast period initiated by retailer personnel.

20. The system of claim 11, wherein the forecast parameters comprise a forecast of the retailer's overall points liability at the end of the defined forecast period.
